(19) United States
(12) Patent Application Publication
(10) Pub. No.: US 2025/0095375 A1
(43) Pub. Date: Mar. 20, 2025

(54) IMAGE PROCESSING APPARATUS, IMAGE PROCESSING METHOD, AND NON-TRANSITORY STORAGE MEDIUM

(71) Applicant: NEC Corporation, Minato- ku, Tokyo (JP)

(72) Inventors: Tingting DONG, Tokyo (JP); Jianquan LIU, Tokyo (JP); Karen STEPHEN, Tokyo (JP); Noboru YOSHIDA, Tokyo (JP); Ryo KAWAI, Tokyo (JP); Satoshi YAMAZAKI, Tokyo (JP); Naoki SHINDOU, Tokyo (JP); Yuta NAMIKI, Tokyo (JP); Youhei SASAKI, Tokyo (JP)

(73) Assignee: NEC Corporation, Minato- ku, Tokyo (JP)

(21) Appl. No.: 18/726,875

(22) PCT Filed: Mar. 16, 2022
(86) PCT No.: PCT/JP2022/011890

§ 371 Date: Jul. 5, 2024

(51) Int. Cl. G06V 20/52; G06T 7/20; G06T 7/70

(52) U.S. Cl. CPC G06V 20/52; G06T 7/20; G06T 7/70

(57) ABSTRACT

An image processing apparatus (10) according to the present invention includes an acquisition unit (11) that acquires a moving image capturing a target area, an analysis unit (12) that generates, based on the moving image, external appearance information indicating at least one of a type of clothing, a type of a personal item, a pose, and a movement of a target person being included in the moving image, and appearance extent information indicating an extent to which the target person appears in the moving image, and an inference unit (13) that infers a purpose for which the target person is present in the target area, based on the external appearance information and the appearance extent information.

### TECHNICAL FIELD

The present invention relates to an image processing apparatus, an image processing method, and a storage medium.

### BACKGROUND ART

Techniques relating to the present invention are disclosed in Patent Documents 1 to 3, and Non-Patent Document 1.

Patent Document 1 discloses a technique for recognizing a uniform, a cap, a company logo, possession of a cardboard box, or the like through an image analysis, and deciding a visit of a delivery worker, based on the recognition result.

Patent Document 2 discloses a technique for extracting, from a moving image, a person whose appearance frequency satisfies a predetermined condition.

Patent Document 3 discloses a technique for computing a feature value of each of a plurality of key points of a human body included in an image, searching for an image including a human body in a similar pose or a human body in a similar movement, based on the feature value being computed, and collectively classifying human bodies in the similar pose or movement.

Non-Patent Document 1 discloses a technique relating to skeleton estimation of a person.

### RELATED DOCUMENT

### Patent Document

Patent Document 1: Japanese Patent Application Publication No. 2021-022767

Patent Document 2: International Patent Publication No. WO2017/077902

Patent Document 3: International Patent Publication No. WO2021/084677

### Non-Patent Document

Non-Patent Document 1: Zhe Cao, Tomas Simon, Shih-En Wei, Yaser Sheikh, “Realtime Multi-Person 2D Pose Estimation using Part Affinity Fields”, The IEEE Conference on Computer Vision and Pattern Recognition (CVPR), 2017, P. 7291-7299

### DISCLOSURE OF THE INVENTION

### Technical Problem

A surveillance camera has been widely spread. Security effectiveness is enhanced not only by simply capturing an image with a surveillance camera but also by inferring a purpose for which a person included in the captured moving image is present, and an inference result can also be used for various purposes.

The technique disclosed in Patent Document 1 is a technique for deciding a visit of a delivery worker, and other purposes cannot be decided. Further, in a case where decision is made only based on an appearance of a person as in the technique disclosed in Patent Document 1, decision accuracy is degraded. For example, in a case where the person is in disguise (for example, disguised as a delivery worker), erroneous decision may be made.

The technique disclosed in Patent Document 2 is a technique for extracting, from a moving image, a person whose appearance frequency satisfies a predetermined condition, and is not a technique for inferring a purpose for which a person including in the moving image is present. Further, in a case where extraction is performed only based on the appearance frequence as in the technique disclosed in Patent Document 2, extraction accuracy is degraded.

Patent Document 3 and Non-Patent Document 1 are techniques for estimating a pose or a movement of a person, and are not techniques for inferring a purpose for which a target person is present in a target area.

In view of the above-mentioned problem, one example of an object of the present invention is to provide an image processing apparatus, an image processing method, and a storage medium that enable accurate inference of a purpose for which a person included in a moving image is present.

### Solution to Problem

According to one example aspect of the present invention, there is provided an image processing apparatus including:
an acquisition unit that acquires a moving image capturing a target area;
an analysis unit that generates, based on the moving image, external appearance information indicating at least one of a type of clothing, a type of a personal item, a pose, and a movement of a target person being included in the moving image, and appearance extent information indicating an extent to which the target person appears in the moving image; and
an inference unit that infers a purpose for which the target person is present in the target area, based on the external appearance information and the appearance extent information.

According to one example aspect of the present invention, there is provided an image processing method including, by a computer:
acquiring a moving image capturing a target area;
generating, based on the moving image, external appearance information indicating at least one of a type of clothing, a type of a personal item, a pose, and a movement of a target person being included in the moving image, and appearance extent information indicating an extent to which the target person appears in the moving image; and
inferring a purpose for which the target person is present in the target area, based on the external appearance information and the appearance extent information.

According to one example aspect of the present invention, there is provided a storage medium storing a program causing a computer to function as:
an acquisition unit that acquires a moving image capturing a target area;
an analysis unit that generates, based on the moving image, external appearance information indicating at least one of a type of clothing, a type of a personal item, a pose, and a movement of a target person being included in the moving image, and appearance extent information indicating an extent to which the target person appears in the moving image; and
an inference unit that infers a purpose for which the target person is present in the target area, based on the external appearance information and the appearance extent information.

### Advantageous Effects of Invention

According to one example aspect of the present invention, it is possible to achieve an image processing apparatus, an image processing method, and a storage medium that enable accurate inference of a purpose for which a person included in a moving image is present.

### BRIEF DESCRIPTION OF THE DRAWINGS

The above-mentioned object, other objects, features, and advantages are further clarified with reference to public example embodiments described below and the following drawings accompanying therewith.

Fig. 1 It is a diagram illustrating one example of a functional block diagram of an image processing apparatus.

Fig. 2 It is a diagram illustrating one example of a hardware configuration example of the image processing apparatus.

Fig. 3 It is a diagram for describing processing of an analysis unit.

Fig. 4 It is a diagram illustrating one example of information being output by the image processing apparatus.

Fig. 5 It is a flowchart illustrating one example of a flow of processing of the image processing apparatus.

Fig. 6 It is a diagram illustrating one example of a functional block diagram of the image processing apparatus.

Fig. 7 It is a diagram illustrating one example of information being output by the image processing apparatus.

### DESCRIPTION OF EMBODIMENTS

Example embodiments of the present invention are described below with reference to the drawings. Note that, in all the drawings, a similar constituent element is denoted with a similar reference sign, and description therefor is omitted as appropriate.

### First Example Embodiment

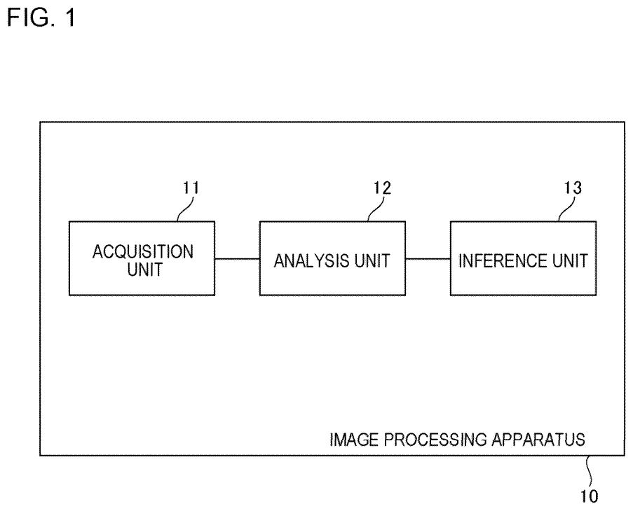

FIG. 1 is a functional block diagram illustrating an overview of an image processing apparatus 10 according to a first example embodiment. The image processing apparatus 10 includes an acquisition unit 11, an analysis unit 12, and an inference unit 13.

The acquisition unit 11 acquires a moving image capturing a target area. The analysis unit 12 generates, based on the moving image, external appearance information indicating at least one of a type of clothing, a type of a personal item, a pose, and a movement of a target person being included in the moving image, and appearance extent information indicating an extent to which the target person appears in the moving image. The inference unit 13 infers a purpose for which the target person is present in the target area, based on the external appearance information and the appearance extent information.

According to the image processing apparatus 10 including such a configuration, a problem in which a purpose for which a person included in a moving image is present can be inferred more accurately is solved.

### Second Example Embodiment

### “Overview”

A processing apparatus 10 according to a second example embodiment is achieved by further embodying the image processing apparatus 10 according to the first example embodiment. The image processing apparatus 10 infers a purpose for which a target person is present in a target area, based on external appearance information indicating at least one of a type of clothing, a type of a personal item, a pose, and a movement of the target person and appearance extent information indicating an extent to which the target person appears in a moving image. A configuration of the image processing apparatus 10 described above is described below more specifically.

### “Hardware Configuration”

Next, one example of a hardware configuration of the image processing apparatus 10 is described. Each of function units of the image processing apparatus 10 is achieved by any combination of hardware and software that mainly include a central processing unit (CPU) of any computer, a memory, a program loaded into the memory, a storage unit such as a hard disk for storing the program (capable of storing a program downloaded from a storage medium such as a compact disc (CD), a server on the Internet, or the like, in addition to a program stored in advance in an apparatus at a time of shipping), and an interface for network connection. Further, a person skilled in the art understands that various modifications may be made to the implementation method and the apparatus.

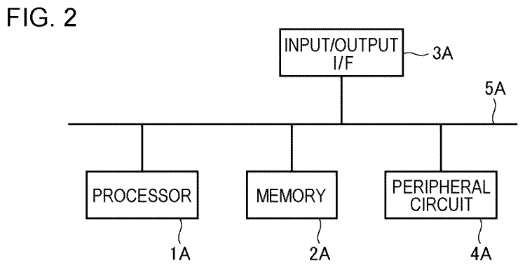

FIG. 2 is a block diagram illustrating a hardware configuration of the image processing apparatus 10. As illustrated in FIG. 2, the image processing apparatus 10 includes a processor 1A, a memory 2A, an input/output interface 3A, a peripheral circuit 4A, and a bus 5A. The peripheral circuit 4A includes various modules. The image processing apparatus 10 may not include the peripheral circuit 4A. Note that, the image processing apparatus 10 may be configured by a plurality of apparatuses that are separated physically and/or logically. In this case, each of the plurality of apparatuses can include the above-mentioned configuration.

The bus 5A is a data transmission path in which the processor 1A, the memory 2A, the peripheral circuit 4A, and the input/output interface 3A mutually transmit and receive data. For example, the processor 1A is an arithmetic processing apparatus such as a CPU and a graphics processing unit (GPU). For example, the memory 2A is a memory such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, and the like. The processor 1A is capable of issuing a command to each of the modules and executing an arithmetic operation, based on the arithmetic operation results.

### “Functional Configuration”

Next, the image processing apparatus 10 according to the second example embodiment is described in detail. FIG. 1 illustrates one example of a functional block diagram of the image processing apparatus 10 according to the second example embodiment. As illustrated therein, the image processing apparatus 10 includes an acquisition unit 11, an analysis unit 12, and an inference unit 13.

The acquisition unit 11 acquires a moving image capturing a target area. The “target area” is an area being captured for a purpose such as surveillance. For example, it is conceivable that the target area may be, but not limited to, a periphery of a porch of a building, a periphery of an exit/entrance of a site, or the like. A camera that captures a moving image at a position and an orientation capturing the target area is installed.

The acquisition unit 11 acquires a moving image being captured by the camera. For example, the camera and the image processing apparatus 10 may be configured to be communicable with each other. Further, the acquisition unit 11 may acquire the moving image being transmitted by the camera. Alternatively, a video file being generated by the camera may be input to the image processing apparatus 10 by any means such as a user input. Further, the acquisition unit 11 may acquire the video file thus input.

The analysis unit 12 generates external appearance information and appearance extent information, based on the moving image being acquired by the acquisition unit 11.

The “external appearance information” indicates at least one of a type of clothing, a type of a personal item, a pose, and a movement of a person (hereinafter, referred to as a “target person”) included in the moving image.

The “type of clothing” indicated in the external appearance information is any one of a plurality of types of clothing that are defined in advance. The plurality of types of clothing are defined in advance in such a way as to include a type of clothing worn by a person who may come into the target area. For example, the person who may come into the target area is a worker who performs various work operations or other persons. The worker may include at least one of a delivery worker who performs delivery, a flier distributer who posts a flier, a gas inspector who checks a gas meter, a water utility worker who checks a tap water meter, and a garbage collecting worker who collects garbage. Note that, the examples given herein are merely examples, and are not limited thereto. Another example is described in the following example embodiment.

It may be assumed that a person described above comes into the target area, and the plurality of types of clothing may be defined in advance in such a way as to include categories associated with various types of uniforms and a category associated with other clothing (plain clothes). The various types of uniforms are uniforms of various workers who may come into the target area, and examples thereof include a uniform worn by a delivery worker from a first company, a uniform worn by a delivery worker from a second company, a uniform worn by a gas inspector, a uniform worn by a water utility worker, a uniform worn by a garbage collecting worker, and the like. Note that, there is a vast variety of plain clothes. In view of this, it can be consolidated into one category labeled as “other clothing (plain clothes)”.

The “type of a personal item” indicated in the external appearance information is any one of a plurality of types of personal item that are defined in advance. The plurality of types of personal item are defined in advance in such a way as to include a type of personal item being typically held by a person who may come into the target area. The examples of the person who may come into the target area are as described above.

It may be assumed that a person described above comes into the target area, and the plurality of types of personal item may be defined in advance in such a way as to include a delivery item, a flier, a dedicated terminal held by a delivery worker, a dedicated terminal held by a gas inspector, a dedicated terminal held by a water utility worker, and the like. Note that, the examples given herein are merely examples, and are not limited thereto. Another example is described in the following example embodiment.

The “pose” and the “movement” that are indicated in the external appearance information are any of a plurality of poses and movements that are defined in advance. The plurality of poses and movements are defined in advance in such a way as to include a pose and a movement that are typically made by a person who may come into the target area. The examples of the person who may come into the target area are as described above.

It may be assumed that a person described above comes into the target area, and the plurality of poses and movements may be defined in advance in such a way as to include a pose and a movement of standing and waiting in front of a door while holding a delivery item, a pose and a movement of handing over a delivery item, a pose and a movement of posing a flier into a post, a pose and a movement of checking a gas meter, a pose and a movement of checking a tap water meter, a pose and a movement of collecting garbage, and the like. Note that, the examples given herein are merely examples, and are not limited thereto. Another example is described in the following example embodiment.

The “appearance extent information” indicates an extent to which the target person appears in a moving image. For example, the appearance extent information may indicate a time length in which the target person is continuously captured in the moving image. Alternatively, the appearance extent information may indicate frequency at which the target person is captured in the moving image within a predetermined period. The predetermined period can be decided optionally, such as a day, a week, and a month. The frequency may be indicated by the number of times at which the target person is captured within the predetermined period, or may be indicated by the time length in which the target person is captured within the predetermined period. The number of times may be counted by various methods. For example, timing at which the target person is captured in the moving image to timing at which the target person is out of the view may be counted as one, or counting may be performed by other methods.

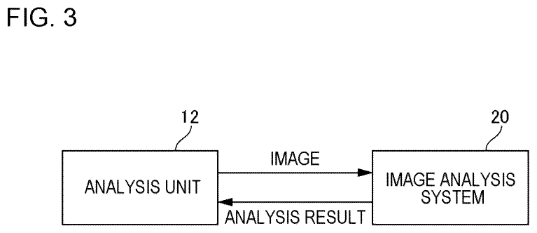

The analysis unit 12 is capable of generating the external appearance information and the appearance extent information, which are described above, based on an analysis result acquired by analyzing a moving image. The analysis of the moving image is performed by an image analysis system 20 being prepared in advance. As illustrated in FIG. 3, the analysis unit 12 inputs a moving image to the image analysis system 20. Further, the analysis unit 12 acquires an analysis result of the moving image from the image analysis system 20. The image analysis system 20 may be a part of the image processing apparatus 10, or may be an external apparatus independent from the image processing apparatus 10 physically and/or logically.

Herein, the image analysis system 20 is described. The image analysis system 20 includes at least one of a face recognition function, a human form recognition function, a pose recognition function, a movement recognition function, an external appearance attribute recognition function, a gradient feature detection function of an image, a color feature detection function of an image, an object recognition function, a character recognition function, and a visual line detection function.

In the face recognition function, a face feature value of a person is extracted. Moreover, a similarity between face feature values may be collated and computed (decision on whether it is the same person or the like). Further, the face feature value being extracted and a face feature value of a person who came into the target area in the past, which is registered in advance in a database, may be collated with each other, and it may be determined whether a person captured in an image is the person who came into the target area in the past.

In the human form recognition function, a human body feature value of a person (for example, indicating an overall feature such as a body shape, i.e., obese or thin, a height, and clothing) is extracted. Moreover, a similarity between human body feature values may be collated and computed (decision on whether it is the same person or the like). Further, the human body feature value being extracted and a human body feature value of a person who came into the target area in the past, which is registered in advance in a database, may be collated with each other, and it may be determined whether a person captured in an image is the person who came into the target area in the past.

In the pose recognition function and the movement recognition function, a joint point of a person is detected, and a stick human model is configured by connecting the joint points to each other. Further, a person is detected based on the stick human model, a height of a person is estimated, a feature value of a pose is extracted, and a movement is determined based on a change of the pose. Specifically, a pose and a movement that are typically made by a person who may come into the above-mentioned target area are defined in advance, and those pose and movement are detected. Moreover, a similarity between pose feature values or a similarity between movement feature values may be collated and computed (decision on whether it is the same pose or the same movement, or the like). Further, the estimated height and a height of a person who came into the target area in the past, which is registered in advance in a database, may be collated with each other, and it may be determined whether a person captured in an image is the person who came into the target area in the past. The pose recognition function and the movement recognition function may be achieved by the above-mentioned techniques disclosed in Patent Document 3 and Non-Patent Document 1.

In the external appearance attribute recognition function, an external appearance attribute associated with a person is recognized (for example, there are over 100 types of external appearance attributes in total including a type of clothing, a color of shoe, a hair style, and wearing of a hat, a necktie, or the like). For example, a type of clothing worn by a person who may come into the above-mentioned target area is defined in advance, and a type of clothing worn by a person captured in an image is recognized. Moreover, a similarity of the external appearance attribute being recognized may be collated and computed (it can be decided whether it is the same attribute). Further, the external appearance attribute being recognized and an external appearance attribute of a person who came into the target area in the past, which is registered in advance in a database, may be collated with each other, and it may be determined whether a person captured in an image is the person who came into the target area in the past.

The gradient feature detection function of an image is SIFT, SURF, RIFF, ORB, BRISK, CARD, HOG, and the like. In this function, a gradient feature of each frame image is detected.

In the color feature detection function of an image, data indicating a color feature of an image, such as a color histogram, is generated. In this function, a color feature of each frame image is detected.

The object recognition function is achieved by an engine such as YOLO (extraction of a general object [a tool used in sports or other performances, a facility, and the like] and extraction of a person are enabled). By using the object recognition function, various objects being defined in advance can be detected from an image. Specifically, a personal item being typically held by a person who may come into the above-mentioned target area is defined in advance, and those personal items are detected.

In the character recognition function, a numeral, a letter, and the like are recognized.

In the visual line detection function, a visual line direction of a person captured in an image is detected.

The analysis unit 12 generates the external appearance information and the appearance extent information, which are described above, based on the above-mentioned analysis result being received from the above-mentioned image analysis system 20.

Referring back to FIG. 1, the inference unit 13 infers a purpose for which the target person is present in the target area, based on the external appearance information and the appearance extent information that are generated by the analysis unit 12.

For example, the inference unit 13 may infer the purpose for which the target person is present in the target area, based on the following criterion.
In a case where a content of the external appearance information satisfies a first condition relating to a worker, and the time length in which the target person continuously appears in the moving image in the appearance extent information is equal to or greater than a first reference value and is less than the second reference value, it is inferred that the purpose for which the target person is present in the target area is a work operation.
In a case where a content of the external appearance information satisfies the first condition relating to a worker, and the time length in which the target person continuously appears in the moving image in the appearance extent information is less than the first reference value, it is inferred that the purpose for which the target person is present in the target area is simple passage.
In a case where a content of the external appearance information satisfies the first condition relating to a worker, and the time length in which the target person continuously appears in the moving image in the appearance extent information is equal to or greater than the second reference value, it is inferred that the purpose for which the target person is present in the target area is a suspicious action.

A content of the first condition, the first reference value, and the second reference value differ for each worker.

For example, a plurality of first conditions are decided in advance for each worker, such as a first condition for a delivery worker from the first company, a first condition for a delivery worker from the second company, a first condition for a gas inspector, a first condition for a water utility worker, a first condition for a garbage collecting worker, and a first condition for a flier distributer.

In the first condition, at least one of a type of clothing, a type of a personal item, a pose, and a movement is specified. For example, in the first condition for a delivery worker from the first company, a uniform of a delivery worker from the first company is specified as the type of clothing, a delivery item is specified as the type of a personal item, and a pose and a movement of standing and waiting in front of a door while holding a delivery item or the like are specified as the pose and the movement. In a case where the content of the external appearance information matches with a content being specified in the first condition, the inference unit 13 decides that the content of the external appearance information satisfies the first condition.

A time range between the first reference value and the second reference value indicates an estimated time required for each work operation performed by each worker in the target area. For example, a plurality of first reference values and second reference values are decided in advance for each worker, such as a first reference value and a second reference value for a delivery worker from the first company, a first reference value and a second reference value for a delivery worker from the second company, a first reference value and a second reference value for a gas inspector, a first reference value and a second reference value for a water utility worker, a first reference value and a second reference value for a garbage collecting worker, and a first reference value and a second reference value for a flier distributer.

According to the above-mentioned criterion, in a case where a time in which the target person continuously appears in the target area falls within the estimated time, it is inferred that the purpose for which the target person is present in the target area is a work operation. Further, in a case where a time in which the target person continuously appears in the target area is less than the estimated time, it is inferred that the purpose for which the target person is present in the target area is simple passage (a case of capturing in the moving image while passing in front of a house or the like). Further, in a case where a time in which the target person continuously appears in the target area is greater than the estimated time, it is inferred that the purpose for which the target person is present in the target area is a suspicious action. As a specific example of the suspicious action, a case in which a person disguised as a worker comes to check out the area before committing a crime is conceivable.

First, the inference unit 13 decides whether the external appearance information relating to the target person satisfies a first condition for any worker. Further, in a case where the external appearance information relating to the target person satisfies the first condition for any worker, it is decided whether the appearance extent information relating to the target person satisfies any one of the above-mentioned three conditions (equal to or greater than the first reference value and less than the second reference value, less than the first reference value, and equal to or greater than the second reference value), based on the first reference value and the second reference value for the worker.

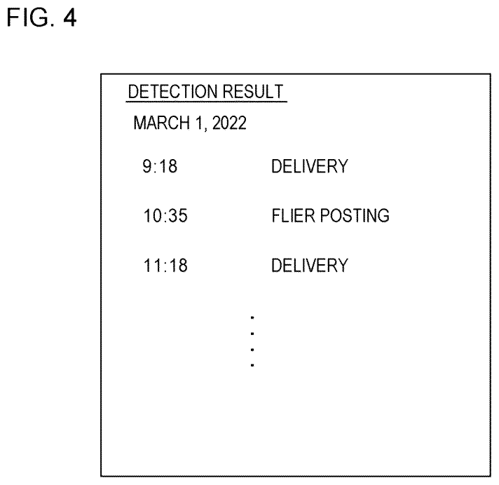

Note that, the inference unit 13 is capable of outputting an inference result. The output includes display through a display or a projection apparatus, printing through a printer, transmission to an external apparatus, and the like. For example, as illustrated in FIG. 4, purposes of a plurality of target persons being detected in a moving image may be displayed in a list with a detection date and time in time-series manner.

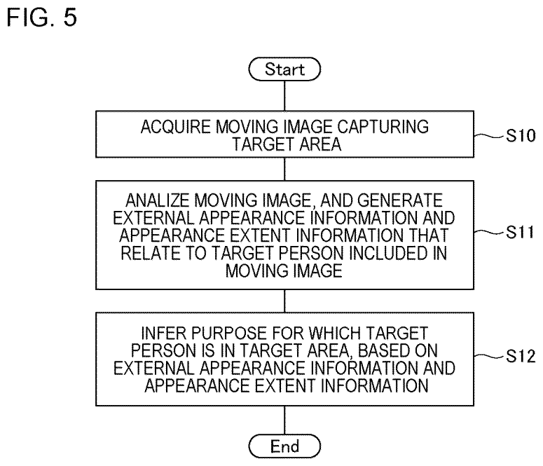

Next, with reference to a flowchart in FIG. 5, one example of a flow of processing of the image processing apparatus 10 is described.

After a moving image capturing a target area is acquired (S10), the image processing apparatus 10 generates, based on the moving image being acquired, external appearance information indicating at least one of a type of clothing, a type of a personal item, a pose, and a movement of a target person being included in the moving image, and appearance extent information indicating an extent to which the target person appears in the moving image (S11). Further, the image processing apparatus 10 infers a purpose for which the target person is present in the target area, based on the external appearance information and the appearance extent information (S12).

### “Advantageous Effect”

According to the image processing apparatus 10 of the second example embodiment, a purpose for which a person is present can be inferred, based on both of external appearance information indicating at least one of a type of clothing, a type of a personal item, a pose, and a movement of the person included in a moving image and appearance extent information indicating an extent to which the person appears in the moving image. Inference accuracy is improved by inferring the purpose, based on both of the external appearance information and the appearance extent information.

Further, the purpose for which the person included in the image is present is inferred by the distinctive criterion described above, and thus a plurality of types of purposes including “a work operation by a worker”, “passage of a worker”, and “a suspicious action by a person disguised as a worker” can be discriminated from each other more accurately.

### Third Example Embodiment

In a third example embodiment, external appearance information relating to a target person further indicates a feature of an external appearance of a vehicle being used by a target person. For example, an analysis unit 12 is capable of determining a vehicle in which the target person rides as a vehicle used by the target person. A vehicle in which the target person rides can be determined by detecting an action of riding on or getting off the vehicle in an image. Further, in a first condition, at least one of a type of clothing, a type of a personal item, a pose, a movement, and a feature of an external appearance of a vehicle is specified. The feature of the external appearance of the vehicle relates to a feature of a design of the vehicle, such as a company logo, a company name, and a pattern unique to a company, which is shown on an external surface of the vehicle or the like. For example, in the first condition for a delivery worker from a first company, a uniform of a delivery worker from the first company is specified as the type of clothing, a delivery item is specified as the type of a personal item, a pose and a movement of standing and waiting in front of a door while holding a delivery item or the like are specified as the pose and the movement, and a feature of an external appearance of a delivery vehicle of the first company is specified as the feature of the external appearance of the vehicle.

Other configurations of an image processing apparatus 10 according to the third example embodiment are similar to the configurations of the image processing apparatus 10 according to the first and second example embodiments.

The image processing apparatus 10 according to the third example embodiment can achieve an advantageous effect similar to that of the image processing apparatus 10 according to the first and second example embodiments. Further, a worker may move by using a vehicle on which a logo of an own company, a company name of an own company, a pattern unique to an own company, or the like is designed. A purpose for which a target person is present in a target area can be inferred more accurately by using a feature of an external appearance of a vehicle used by the target person.

### Fourth Example Embodiment

In a fourth example embodiment, other specific examples of processing of inferring a purpose for which a target person is present in a target area, based on external appearance information and appearance extent information, is indicated.

For example, in a case where a uniform of a delivery worker from a first company is worn, a delivery item is held, and an appearance frequency is equal to or greater than a reference value (for example, five times or more in a latest week), an inference unit 13 can infer a delivery worker from the first company whose purpose is to deliver a delivery item.

Further, in a case where other clothing (plain clothes) is worn, a bundle of paper (a flier) is held, and the appearance frequency is equal to or less than the reference value (for example, less than twice in the latest week), the inference unit 13 can infer a flier posting person whose purpose is to post a flier.

Further, in a case where other clothing (plain clothes) is worn, a predetermined case is carried, and the appearance frequency is equal to or less than the reference value (for example, less than four times in the latest week), the inference unit 13 can infer a delivery worker whose purpose is to deliver food.

Further, in a case where a pose and a movement of checking a tap water meter are made, and the appearance frequency falls within a predetermined reference range (for example, once or twice in the latest month), the inference unit 13 can infer a water utility worker whose purpose is to check a tap water meter.

Further, in a case where a pose and a movement of checking a gas meter are made, and the appearance frequency falls within the predetermined reference range (for example, once or twice in the latest month), the inference unit 13 can infer a gas inspector whose purpose is to check a gas meter.

Further, in a case where a uniform of a garbage collecting worker is worn, any object is held, a garbage collecting vehicle is used, and the appearance frequency is equal to or less than the reference value (for example, less than five times in the latest week), the inference unit 13 can infer a garbage collecting worker whose purpose is to collect garbage.

Further, in a case where other clothing (plain clothes) is worn, pocket tissue is held, and a time length of continuous appearance in a moving image satisfies a predetermined condition (for example, three hours to eight hours), the inference unit 13 can infer a pocket tissue distributer whose purpose is to distribute pocket tissue.

Further, in a case where a uniform of a predetermined moving company is worn, baggage is held, a truck is used, and the time of continuous appearance in a moving image satisfies the predetermined condition (for example, 30 minutes to two hours), the inference unit 13 can infer a mover whose purpose is to perform moving work.

Further, in a case where a predetermined uniform is worn, a pose of performing traffic guide while holding a stick or a flag in a hand is made, and the time of continuous appearance in a moving image satisfies the predetermined condition (for example, one hour to eight hours), the inference unit 13 can infer a traffic guide person whose purpose is to perform traffic guide.

Further, in a case where a predetermined uniform is worn, a construction tool such as a road repair tool is held in a hand, appearance is made in periphery of a road, and the time of continuous appearance in a moving image satisfies the predetermined condition (for example, three hours to eight hours), the inference unit 13 can infer a road construction worker whose purpose is to perform road maintenance.

Further, in a case where a predetermined uniform is worn, a tool such as a counter is held in a hand, appearance is made in periphery of a road or an intersection, and the time of continuous appearance in a moving image satisfies the predetermined condition (for example, equal to or more than one hour), the inference unit 13 can infer a traffic volume surveyor whose purpose is to survey a traffic volume.

Further, in a case where a police uniform is worn, a police motorcycle or a police car is used, and the time of continuous appearance in a video satisfies the predetermined condition (for example, equal to or more than one hour), the inference unit 13 can infer a traffic police officer whose purpose is to conduct traffic control or investigation of a traffic accident.

Further, in a case where a predetermined uniform is worn, a sign board is held in a hand, and the time of continuous appearance in a moving image satisfies the predetermined condition (for example, one hour to eight hours), the inference unit 13 can infer a sign board holding staff member whose purpose is to guide with the sign board.

Further, in a case where a predetermined uniform is worn, a cleaning tool is held in a hand, appearance is made in periphery of a roadside water drain, and the time of continuous appearance in a moving image satisfies the predetermined condition (for example, two minutes to two hours), the inference unit 13 can infer a road cleaning worker whose purpose is to clean a roadside water drain.

Further, in a case where a predetermined uniform is worn, a flower, a plant, a pot, a watering tool, or the like is held in a hand, appearance is made in periphery of a flower bed or a planter, and the time of continuous appearance in a moving image satisfies the predetermined condition (for example, 30 minutes to five hours), the inference unit 13 can infer a flower planting worker whose purpose is to perform flower planting work.

Further, in a case where other clothing (plain clothes) is worn, a packed lunch and a table (personal item) are placed nearby, and the time of continuous appearance in a moving image satisfies the predetermined condition (for example, 30 minutes to three hours), the inference unit 13 can infer a packed-lunch street vendor whose purpose is to sell a packed lunch on a street.

Further, in a case where other clothing (plain clothes) is worn, a microphone or musical instrument (personal item) is placed nearby, a movement of walking or dancing is made, and the time of continuous appearance in a moving image satisfies the predetermined condition (for example, 30 minutes to five hours), the inference unit 13 can infer a street performer whose purpose is to perform music street performance.

Other configurations of an image processing apparatus 10 according to the fourth example embodiment are similar to the configurations of the image processing apparatus 10 according to the first to third example embodiments.

The image processing apparatus 10 according to the fourth example embodiment can achieve an advantageous effect similar to that of the image processing apparatus 10 according to the first to third example embodiments. Further, according to the image processing apparatus 10 of the fourth example embodiment, various purposes for which various person are present at a site can be inferred.

### Fifth Example Embodiment

An image processing apparatus 10 according to a fifth example embodiment includes a function of executing statistic processing by time period for an inference result of a purpose for which a target person is present in a target area.

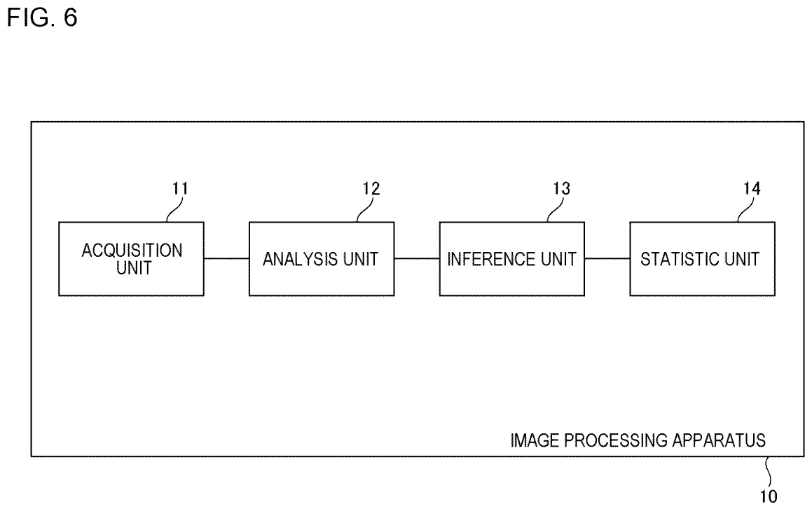

FIG. 6 illustrates one example of a functional block diagram of the image processing apparatus 10 according to the fifth example embodiment. As illustrated therein, the image processing apparatus 10 includes an acquisition unit 11, an analysis unit 12, an inference unit 13, and a statistic unit 14.

The statistic unit 14 executes statistic processing by time period for an inference result of a purpose for which a target person is present in a target area. Further, the statistic unit 14 is capable of outputting a result of the statistic processing. The output includes display through a display or a projection apparatus, printing through a printer, transmission to an external apparatus, and the like.

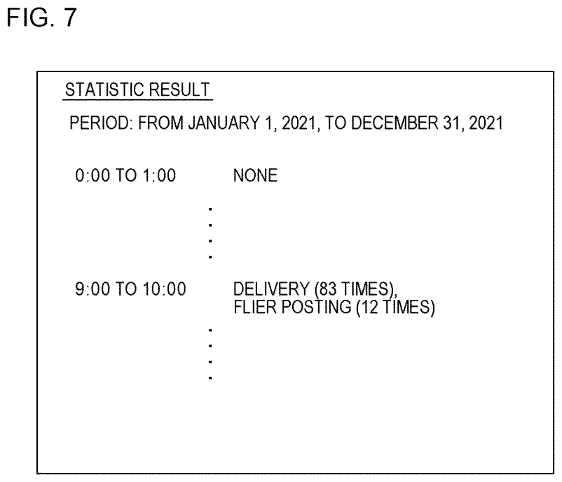

FIG. 7 illustrates one example of the result of the statistic processing by the statistic unit 14. In the illustrated example, each purpose and the number of times at which each purpose is inferred, in other words, the number of times at which a person who is in the target area for each purpose is detected is indicated by time period.

The other configurations of the image processing apparatus 10 according to the fifth example embodiment are similar to the configurations of the image processing apparatus 10 according to the first to fourth example embodiments.

The image processing apparatus 10 according to the fifth example embodiment can achieve an advantageous effect similar to that of the image processing apparatus 10 according to the first to fourth example embodiments. Further, according to the image processing apparatus 10 of the fifth example embodiment, an inference result of a purpose for which a target person is present in a target area can be subjected to statistic processing by time period, and can be output. A user can utilize the information for a security purpose or for marketing purpose.

While the example embodiments of the present invention have been described with reference to the drawings, the example embodiments are only exemplification of the present invention, and various configurations other than the above-described example embodiments can also be employed. The configurations of the example embodiments described above may be combined with each other, or some of the configurations may be replaced with other of the configurations. Further, various changes may be made to the configurations of the example embodiments described above in an extent without departing from the gist. Further, the configurations or the processing that are disclosed in the example embodiments and the modification examples described above may be combined with each other.

Further, in the flowchart used in the description given above, a plurality of steps (pieces of processing) are described in order, but the execution order of the steps executed in each of the example embodiments is not limited to the described order. In each of the example embodiments, the order of the illustrated steps may be changed in an extent without interfering with the contents. Further, the example embodiments described above may be combined with each other within a range where the contents do not conflict with each other

The whole or a part of the example embodiments described above can be described as, but not limited to, the following supplementary notes.
1. An image processing apparatus including:
   an acquisition unit that acquires a moving image capturing a target area;
   an analysis unit that generates, based on the moving image, external appearance information indicating at least one of a type of clothing, a type of a personal item, a pose, and a movement of a target person being included in the moving image, and appearance extent information indicating an extent to which the target person appears in the moving image; and
   an inference unit that infers a purpose for which the target person is present in the target area, based on the external appearance information and the appearance extent information.
2. The image processing apparatus according to supplementary note 1, wherein,
   in a case where the external appearance information satisfies a first condition relating to a worker, and a time length in which the target person continuously appears in the moving image is equal to or greater than a first reference value and is less than a second reference value in the appearance extent information, the inference unit infers that the purpose is a work operation.
3. The image processing apparatus according to supplementary note 2, wherein,
   in a case where the external appearance information satisfies the first condition, and a time length in which the target person continuously appears in the moving image is less than the first reference value in the appearance extent information, the inference unit infers that the purpose is passage.
4. The image processing apparatus according to supplementary note 2 or 3, wherein,
   in a case where the external appearance information satisfies the first condition, and a time length in which the target person continuously appears in the moving image is equal to or greater than the second reference value in the appearance extent information, the inference unit infers that the purpose is a suspicious action.
5. The image processing apparatus according to any one of supplementary notes 2 to 4, wherein
   the worker includes at least one of a delivery worker who performs delivery as the work operation, a flier distributer who posts a flier as the work operation, a gas inspector who checks a gas meter as the work operation, a water utility worker who checks a tap water meter as the work operation, and a garbage collecting worker who collects garbage as the work operation.
6. The image processing apparatus according to any one of supplementary notes 1 to 5, wherein
   the external appearance information further indicates a feature of an external appearance of a vehicle being used by the target person.
7. The image processing apparatus according to any one of supplementary notes 1 to 6, further including
   a statistic unit that executes statistic processing by time period for an inference result of a purpose for which the target person is present in the target area.
8. An image processing method including, by a computer:
   acquiring a moving image capturing a target area;
   generating, based on the moving image, external appearance information indicating at least one of a type of clothing, a type of a personal item, a pose, and a movement of a target person being included in the moving image, and appearance extent information indicating an extent to which the target person appears in the moving image; and
   inferring a purpose for which the target person is present in the target area, based on the external appearance information and the appearance extent information.
9. A storage medium storing a program causing a computer to function as:
   an acquisition unit that acquires a moving image capturing a target area;
   an analysis unit that generates, based on the moving image, external appearance information indicating at least one of a type of clothing, a type of a personal item, a pose, and a movement of a target person being included in the moving image, and appearance extent information indicating an extent to which the target person appears in the moving image; and
   an inference unit that infers a purpose for which the target person is present in the target area, based on the external appearance information and the appearance extent information.

### REFERENCE SIGNS LIST

10 Image processing apparatus
11 Acquisition unit
12 Analysis unit
13 Inference unit
14 Statistic unit
1A Processor
2A Memory
3A Input/output I/F
4A Peripheral circuit
5A Bus

What is claimed is:

1. An image processing apparatus comprising:
at least one memory configured to store one or more instructions; and
at least one processor configured to execute the one or more instructions to:
acquire a moving image capturing a target area;
generate, based on the moving image, external appearance information indicating at least one of a type of clothing, a type of a personal item, a pose, and a movement of a target person being included in the moving image, and appearance extent information indicating an extent to which the target person appears in the moving image; and
infer a purpose for which the target person is present in the target area, based on the external appearance information and the appearance extent information.

2. The image processing apparatus according to claim 1, wherein the at least one processor is further configured to execute the one or more instructions to, in a case where the external appearance information satisfies a first condition relating to a worker, and a time length in which the target person continuously appears in the moving image is equal to or greater than a first reference value and is less than a second reference value in the appearance extent information, infer that the purpose is a work operation.

3. The image processing apparatus according to claim 2, wherein the at least one processor is further configured to execute the one or more instructions to, in a case where the external appearance information satisfies the first condition, and a time length in which the target person continuously appears in the moving image is less than the first reference value in the appearance extent information, infer that the purpose is passage.

4. The image processing apparatus according to claim 2, wherein
the at least one processor is further configured to execute the one or more instructions to, in a case where the external appearance information satisfies the first condition, and a time length in which the target person continuously appears in the moving image is equal to or greater than the second reference value in the appearance extent information, infer that the purpose is a suspicious action.

5. The image processing apparatus according to claim 2, wherein
the worker includes at least one of a delivery worker who performs delivery as the work operation, a flier distributer who posts a flier as the work operation, a gas inspector who checks a gas meter as the work operation, a water utility worker who checks a tap water meter as the work operation, and a garbage collecting worker who collects garbage as the work operation.

6. The image processing apparatus according to claim 1, wherein
the external appearance information further indicates a feature of an external appearance of a vehicle being used by the target person.

7. The image processing apparatus according to claim 1,
wherein the at least one processor is further configured to execute the one or more instructions to
execute statistic processing by time period for an inference result of a purpose for which the target person is present in the target area.

8. An image processing method comprising, by a computer:
acquiring a moving image capturing a target area;
generating, based on the moving image, external appearance information indicating at least one of a type of clothing, a type of a personal item, a pose, and a movement of a target person being included in the moving image, and appearance extent information indicating an extent to which the target person appears in the moving image; and
inferring a purpose for which the target person is present in the target area, based on the external appearance information and the appearance extent information.

9. A non-transitory storage medium storing a program causing a computer to:
acquire a moving image capturing a target area;
generate, based on the moving image, external appearance information indicating at least one of a type of clothing, a type of a personal item, a pose, and a movement of a target person being included in the moving image, and appearance extent information indicating an extent to which the target person appears in the moving image; and
infer a purpose for which the target person is present in the target area, based on the external appearance information and the appearance extent information.

10. The image processing method according to claim 8, wherein,
in a case where the external appearance information satisfies a first condition relating to a worker, and a time length in which the target person continuously appears in the moving image is equal to or greater than a first reference value and is less than a second reference value in the appearance extent information, the computer infers that the purpose is a work operation.

11. The image processing method according to claim 10, wherein,
in a case where the external appearance information satisfies the first condition, and a time length in which the target person continuously appears in the moving image is less than the first reference value in the appearance extent information, the computer infers that the purpose is passage.

12. The image processing method according to claim 10, wherein,
in a case where the external appearance information satisfies the first condition, and a time length in which the target person continuously appears in the moving image is equal to or greater than the second reference value in the appearance extent information, the computer infers that the purpose is a suspicious action.

13. The image processing method according to claim 10, wherein
the worker includes at least one of a delivery worker who performs delivery as the work operation, a flier distributer who posts a flier as the work operation, a gas inspector who checks a gas meter as the work operation, a water utility worker who checks a tap water meter as the work operation, and a garbage collecting worker who collects garbage as the work operation.

14. The image processing method according to claim 8, wherein
the external appearance information further indicates a feature of an external appearance of a vehicle being used by the target person.

15. The image processing method according to claim 8, wherein the computer executes statistic processing by time period for an inference result of a purpose for which the target person is present in the target area.

16. The non-transitory storage medium according to claim 9, wherein the program causing the computer to, in a case where the external appearance information satisfies a first condition relating to a worker, and a time length in which the target person continuously appears in the moving image is equal to or greater than a first reference value and is less than a second reference value in the appearance extent information, infer that the purpose is a work operation.

17. The non-transitory storage medium according to claim 16, wherein the program causing the computer to, in a case where the external appearance information satisfies the first condition, and a time length in which the target person continuously appears in the moving image is less than the first reference value in the appearance extent information, infer that the purpose is passage.

18. The non-transitory storage medium according to claim 16, wherein the program causing the computer to, in a case where the external appearance information satisfies the first condition, and a time length in which the target person continuously appears in the moving image is equal to or greater than the second reference value in the appearance extent information, infer that the purpose is a suspicious action.

19. The non-transitory storage medium according to claim 16, wherein
the worker includes at least one of a delivery worker who performs delivery as the work operation, a flier distributer who posts a flier as the work operation, a gas inspector who checks a gas meter as the work operation, a water utility worker who checks a tap water meter as the work operation, and a garbage collecting worker who collects garbage as the work operation.

20. The non-transitory storage medium according to claim 9, wherein the external appearance information further indicates a feature of an external appearance of a vehicle being used by the target person.
